(19) United States
(12) Patent Application Publication
(10) Pub. No.: US 2004/0083864 A1
(43) Pub. Date: May 6, 2004

(54) Punch and setting tool and method of securing scrapbook media

(75) Inventor: Bridgette Server, Centerville, UT (US)

Correspondence Address: THORPE NORTH & WESTERN, LLP., 8180 SOUTH 700 EAST, SUITE 200, P.O. BOX 1219, SANDY, UT, 84070, US

(73) Assignee: Making Memories Wholesale, Inc.

(21) Appl. No.: 10/645,371

(22) Filed: Aug. 21, 2003

Related U.S. Application Data
(60) Provisional application No. 60/423,257, filed on Oct. 31, 2002.

(51) Int. Cl. B26D 3/00

(52) U.S. Cl. 83/13

(57) ABSTRACT

A combination punching and setting tool and method includes an elongate body with an upper impact end, a lower attachment end, and at least one interchangeable tip interchangeably received on the attachment end. The interchangeable tip is selected from the group consisting of i) a punching tip configured to punch an opening in a base material, and ii) a setting tip configured to set a securing device placed in an opening in the base material. The elongate body includes an ejection chute for ejecting base material punched by the punching tip out of the elongate body. The setting tip may include a pattern, formed on a lower end of the tip, configured to form a corresponding pattern on the securing device when the securing device is set.

This application claims priority from U.S. Provisional Patent Application Serial No. 60/423,257, filed on Oct. 31, 2002.

### BACKGROUND OF THE INVENTION

1. Field of the Invention

The present invention relates generally to scrapbook and photo album activities. More particularly, the present invention relates to tools for use in punching openings in material and setting fasteners installed in material and securing scrapbook media.

2. Related Art

Preserving memories in scrapbooks and photo albums has become an increasingly popular pastime, in which photos and other memorabilia are combined in creative and expressive presentations. Numerous supplies are provided to allow an individual to customize their photos and memorabilia. For example, such supplies include various papers with printed patterns, borders, cutout shapes, etc. The various papers and patterns can be combined to customize a page in the scrapbook, often giving the page a theme. For example, photos of a football game may be laid out on paper having a football field print, while papers patterned as footballs are positioned around the photos.

Scrapbook supplies are not limited to paper supplies, but can include pens, markers, stamps, etc. In addition, various specialized tools have been developed to cut, crop, decorate, etc. the photos and paper.

### SUMMARY OF THE INVENTION

It has been recognized that it would be advantageous to provide improved tools for setting fasteners in base paper as part of scrapbook activities.

The invention provides a punch tool, set tool, and/or combination punching and setting tool that includes an elongate body with an upper impact end, a lower attachment end, and at least one interchangeable tip interchangeably received on the attachment end. The interchangeable tip is selected from the group consisting of i) a punching tip configured to punch an opening in a base material, and ii) a setting tip configured to set a securing device placed in an opening in the base material.

In accordance with a more detailed aspect of the present invention, the elongate body can include an ejection chute, formed in the body, and configured to allow base material punched by the punching tip to be ejected out of the elongate body.

In accordance with another more detailed aspect of the present invention, the tool can further include a plurality of interchangeable punching tips, each tip having a cutting orifice configured to cut a hole in the base material, a size of a cutting orifice in each tip being different than a size of a cutting orifice in alternate tips.

In accordance with another more detailed aspect of the present invention, the attachment end of the body can include screw threads, and each interchangeable punching and setting tip can include screw threads, the respective threads being configured to enable selective, threadable coupling of the interchangeable tips to the body.

In accordance with yet another more detailed aspect of the present invention, the setting tips can each include a raised pattern formed on the tip and configured to create a corresponding pattern on the securing device upon setting the securing device.

In accordance with another more detailed aspect of the present invention, the invention can provide a setting tool for setting a securing device, including an elongate body having an upper impact end and a lower attachment end, and at least one interchangeable setting tip. The tool can be configured to receive an interchangeable setting tip at the attachment end, and can be impacted at the impact end to drive the setting tip onto the securing device to set the securing device.

In accordance with another more detailed aspect of the present invention, the invention can provide a patterned setting tip which can be interchangeably attached to a setting tool. The setting tip can include attachment means disposed on a top of the tip for attaching the tip to a setting tool, and a pattern, formed on a lower end of the tip. The tip being configured to strike a securing device to set the securing device, and to form a corresponding pattern in the securing device once set.

The present invention also provides a method for fastening at least two mediums of a scrapbook or photo album. Corresponding holes are formed in the at least two mediums. The mediums can be scrapbook pages, photo album pages, photos, and decorative paper. The holes can be formed with a punching tip placed against and forced against the mediums. The holes in the at least two mediums are aligned, and an eyelet disposed through the holes. A setting tip is placed against a top of the eyelet, and an upper impact end of an elongate body attached to the setting tip is struck to deform the upper end of the eyelet.

In accordance with one more detailed aspect of the present invention, a setting tip with a raised pattern is placed against the top of the eyelet. Striking sets the eyelet and creates a corresponding pattern of the raised pattern on the eyelet.

In accordance with another more detailed aspect of the present invention, an interchangeable punching tip can be attached to the elongate body prior to forming the holes in the mediums. The punching tip can be removed from the elongate body after forming the holes in the mediums. The setting tip can then be attached to the elongate body prior to placing the setting tip against the top of the eyelet.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 a is a side, exploded view of one embodiment of a setting tool in accordance with the present invention.

FIG. 1b is an end view of one embodiment of a setting tip having a raised pattern in accordance with the present invention.

FIG. 1c is an end view of another embodiment of a setting tip having a raised pattern.

FIG. 1d is an end view of yet another embodiment of a setting tip having a raised pattern.

FIG. 2a is a side, cross-sectional view of a securing device set using a setting tool in accordance with the present invention.

FIG. 2b is a top view of the securing device illustrated in FIG. 2a, after having been set.

FIG. 2c is a side, cross-sectional view of a securing device and setting tip immediately prior to striking the securing device to set it into the base material.

FIG. 3a is a side view of one embodiment of a combination punching and setting tool in accordance with the present invention.

FIG. 3b is a side, exploded view of the tool illustrated in FIG. 3a, showing an interchangeable punching tip and setting tip.

FIG. 3c is an end view of a punching tip.

FIGS. 4a-4h are side and end views of interchangeable punching tips having different sizes and/or shapes of cutting orifices.

FIG. 5a is a perspective view of a combination tool in accordance with the present invention, having a punching tip attached thereto, and being used to punch a hole in base material.

FIG. 5b is a perspective view of the combination tool of FIG. 5a, having a setting tip attached thereto, and being used to set a securing device in the base material.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

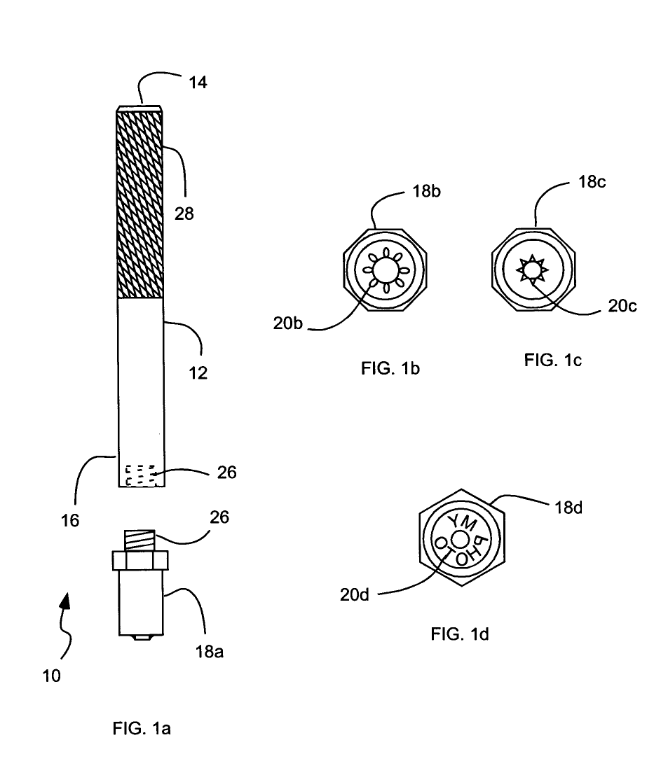

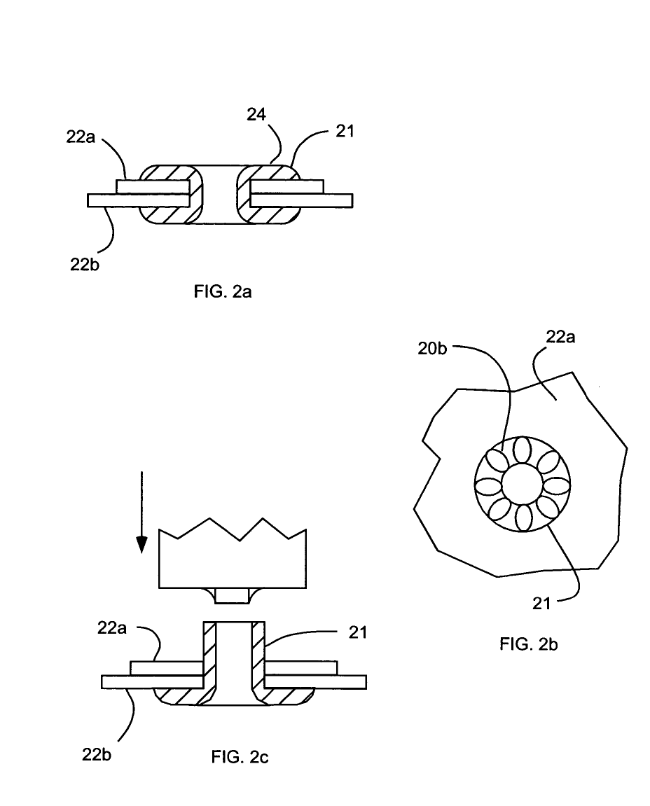

As illustrated in FIGS. 1a-1d, a setting tool 10 in accordance with the present invention is provided. The tool 10 includes an elongate body 12 with an upper impact end 14 and a lower attachment end 16, in accordance with one aspect of the present invention. At least one interchangeable setting tip 18a-d is also provided, each setting tip being configured to be interchangeably coupled to the attachment end 16 of the elongate body to provide a setting interface for setting securing devices (24 in FIGS. 2a-c). For instance, once equipped with a setting tip 18, the setting tool 10 can be used to “set” or attach an eyelet to a base material or media, such as paper or photos.

As shown in FIGS. 1b-1d, the setting tips 18 can include variety of raised patterns 20b, 20c and 20d formed on the base or tip of the setting tip, to transfer a corresponding pattern to the securing device to be set. The raised pattern thus forms or impresses the pattern on the head of the securing device. The raised patterns can be any desired pattern, such as a decorative pattern, including geometric designs, pictures, etc., as shown in FIGS. 1b and 1c. Alternatively, as shown in FIG. 1d, the raised pattern 20d may comprise indicia such as alphanumeric characters, symbols, logos, etc. As shown in FIG. 1b, pattern 20b differs from pattern 20c in both design and size. The patterns can vary according to both appearance and size, such that a series of identical patterns can be provided in a variety of sizes, or a series of different patterns can be provided in a similar size, or any combination of the two. In addition, as shown in FIG. 1c, the setting tip 18c can include a sharp blade 20c to score or cut the securing device.

The setting tool provides an easily used tool for setting securing devices, such as eyelets. As shown in FIGS. 2a-2c, one use of the setting tool can be in the situation where two materials or media are to be riveted or otherwise secured to each other. For instance, base material or media 22a can be coupled to base material 22b through the use of an eyelet 21, such as a metal eyelet. The base materials 22a and 22b can be paper, such as decorative paper, card stock, scrapbook pages, photos in a scrapbook, photo album pages, or other materials.

To secure the materials together, a user would first form holes in both base materials 22a and 22b. The eyelet 21, in an “unset” configuration, shown in FIG. 2c, is then inserted through the aligned holes. The setting tool 10 is then used to “set” the eyelet, that is, strike the unset end of the eyelet to crush or score the top or head 24 of the eyelet so that the eyelet is flattened, as shown in FIG. 2a, so that a portion of the eyelet surrounding the hole in the base material is deformed to be larger than the hole, thus providing a secure hold on both base materials. This can be done to secure the base materials while still allowing the base materials to rotate relative to each other. Alternatively, the materials can be rigidly, or non-pivotally, attached. The setting tool or tips spread the tubular eyelet outwardly and downwardly. As shown in FIG. 2b, when the interchangeable setting tip 18b is used on the setting tool, a decorative pattern 20b is transferred from the setting tip to the eyelet 21—the pattern being essentially forged on the top of the metal eyelet by the raised pattern on the setting tip—providing both a secure connection between the base materials, and a decorative finish on the eyelet.

While the present invention can be advantageously used in a variety of applications, one application that can benefit from the invention is in craft work or “scrapbooking.” Scrapbooking has lately developed as a method to preserve photos in an album containing decorated or stylized pages. For instance, a scrapbooker may have a series of photographs of a family taken on a family camping trip. One or more thematically related photos of the trip can be arranged on a page, and decals, paper cutouts, lettering, etc. can be applied to the page to enhance the effect provided by the photos. The additions applied to the page around the photos are often thematically related to the photos. For example, in the camping trip example given, icons such as campfires, fishing poles, etc. can be placed around the photos to supplement the photos.

With the present invention, users can attach paper cutouts or other additions to the page with an eyelet or rivet. The addition to the page can then be more or less permanently attached to the page, either rotatably or fixedly. Moreover, fasteners such as eyelets, rivets, etc. avoid some of the drawbacks frequently associated with chemical adhesives such as glue, adhesive tape, etc., especially where photographs are to be fastened. The present invention can be advantageously used to set the rivet or eyelet into the page, thus providing scrapbookers an easily used tool to set eyelets, rivets, grommets, and the like. In addition, the present invention leaves the set eyelet or rivet with a decorative imprint, which further enhances the aesthetic appearance of the page.

The patterns on the interchangeable tips 18 can be selected according to a theme of the page being decorated. For instance, a pattern formed in a flower design can be used to set eyelets used on outdoor-themed pages. Of course, any pattern can be applied to the setting tips, including star designs, flower designs, etc. Likewise, symbols, numbers and characters can also be provided on the setting tip. As suggested by FIG. 1c, it will be apparent that the imprint on the eyelet or rivet will be a mirror image of the raised pattern disposed on the setting tip.

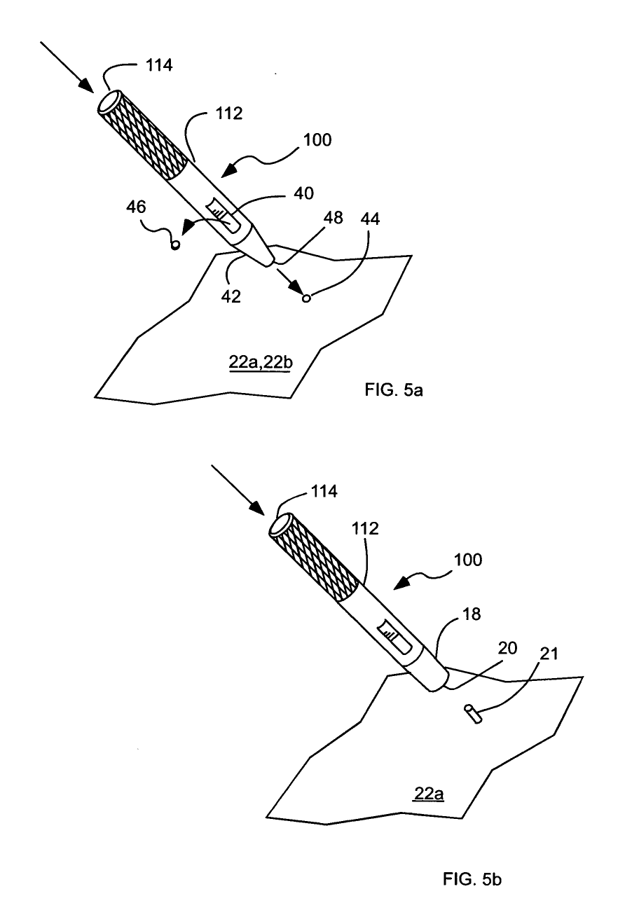

Referring to FIGS. 2c and 5b, in use, a user would first place the setting tip on or near the unset eyelet 21, then strike the impact end 14 of the setting tool with a hammer or other striking device. The resulting force deforms or scores the eyelet to both set the eyelet, and impart the pattern on the setting tip to the eyelet. By varying the impact force imparted to the setting tool, a user can vary the pattern formed on the eyelet by the setting tip. For instance, the pattern 20b shown in FIG. 2b may appear as a flower formed of a series of petals. This effect can be achieved by fully setting the eyelet with the setting tool, which results in individual petals being formed. A user may vary this effect by not applying as much impact force to the setting tool, and only scoring, or partially deforming or setting the eyelet. This can provide a differently appearing effect, as the petals of the flower are not fully developed and may appear as a budding flower.

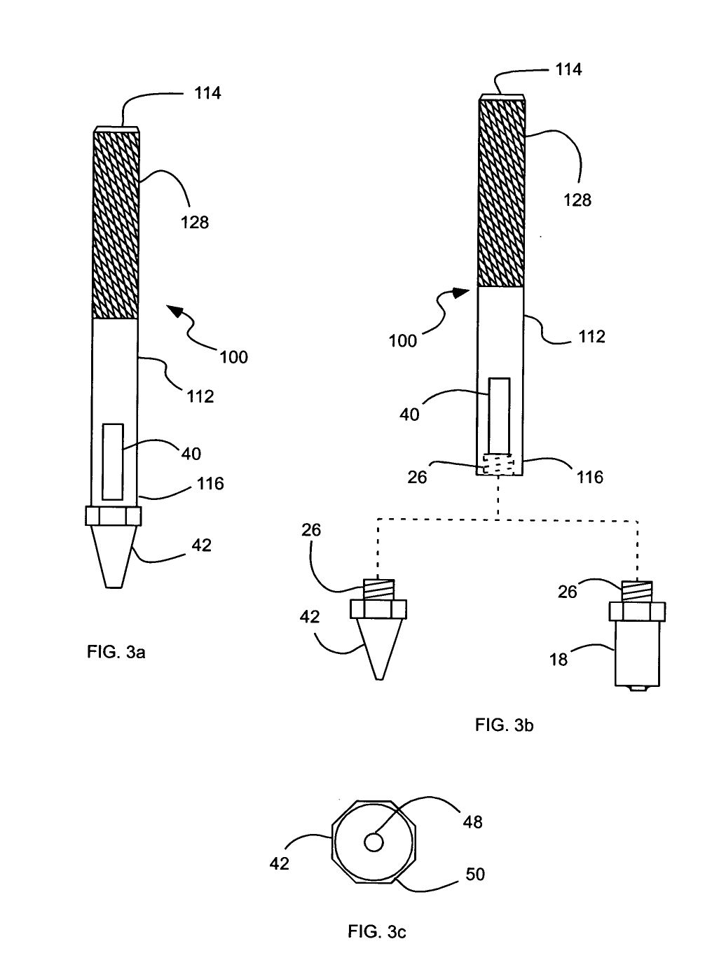

The elongate body 12 and interchangeable setting tips 18 can be coupleable to each other in a number of ways. In the embodiments illustrated in FIGS. 1a and 3b, the elongate body and setting tips each include threads 26. The setting tips can thus be threaded into or onto the elongate body for use. When it is desired to change the setting tip being used, the first tip can be quickly threaded off the elongate body, and the second tip can be quickly threaded onto the elongate body. Thus, a user can quickly and easily move from one tip to another. Of course, the setting tips can also be coupleable to the elongate body in other ways, such as snapping on the body, pressing onto the body, matched magnets, etc., as would occur to one skilled in the art. As shown at 28 in FIG. 1a, the elongate body can also include a knurled finish to enable a user to securely grasp the setting tool.

In accordance with another embodiment, the present invention also provides a combination punching and setting tool 100, illustrated in FIGS. 3a-3c. Here, an elongate body 112 is provided and includes an upper impact end 114 and a lower attachment end 116. Also included is at least one interchangeable punching tip 42, and at least one interchangeable setting tip 18. The combination punching and setting tool can be used by a user to first interchangeably receive a punching tip 42 having a cutting orifice 48 to allow the tool to punch an opening in a base material. After the opening, or hole, has been formed in the base material, the punching tip can be quickly removed, so that the tool can interchangeably receive a setting tip 18 to allow the tool to be used to set a securing device placed in the base material. Both the interchangeable punching tips 42 and setting tips 18 can include shoulders 50 which can enable easier threading of the tips on and off the elongate body. The shape of the shoulders can be selected to facilitate grasping and turning manually, and/or to be compatible with a wrench or other tool. For example, the shoulders can be octagonal, as depicted in FIG. 1b, or hexagonal, as shown in FIG. 1c. Other shapes can also be used, and gripping devices, such as a knurled surface, can also be provided.

The combination tool 100 can thus be used to complete the tasks discussed in relation to FIGS. 2a-2c, without requiring multiple tools to perform each step. For instance, when it is desired to install an eyelet 21 into the base materials 22a and 22b, a punching tip 42 can be attached to the attachment end 116 of the tool. The user would then strike the impact end 114 of the tool to drive the cutting orifice 48 of the punching tip through the base materials to form a hole or opening 44 in the base materials. The punching tip can then be removed from the elongate body 112, and a setting tip 18 can be attached to the elongate body. The eyelet or rivet can be placed in the opening in the base materials, and the setting tip can be used to both set the rivet or eyelet and create a decorative pattern 20b on the rivet or eyelet.

As shown in FIG. 5a, the combination tool 100 incorporates all of the advantages of other embodiments disclosed herein, and in addition also advantageously includes an ejection chute 40. The ejection chute can be formed in the elongate body 112 to provide an open channel through the interior of the elongate body in communication with the cutting orifice 48 in the punching tip 42. Because of the ejection chute, multiple holes 44 can be formed in the base material 22c, without requiring the user to clear from the punching tip the small chips 46 of base material that are removed to form the holes. Shown in operation in FIG. 5a, a user first places the cutting orifice 48 of the punching tip 42 on the base material 22c at a location of a desired hole. The operator then strikes the tool 100 on the impact end 114 to force the punching tip trough the base material. This removes a chip 46 from the base material, and, with repeated punching of additional holes, multiple chips are forced up the cutting orifice and into the channel formed in the elongate body. The chips 46 are then easily ejected or removed from the ejection chute formed in the elongate body.

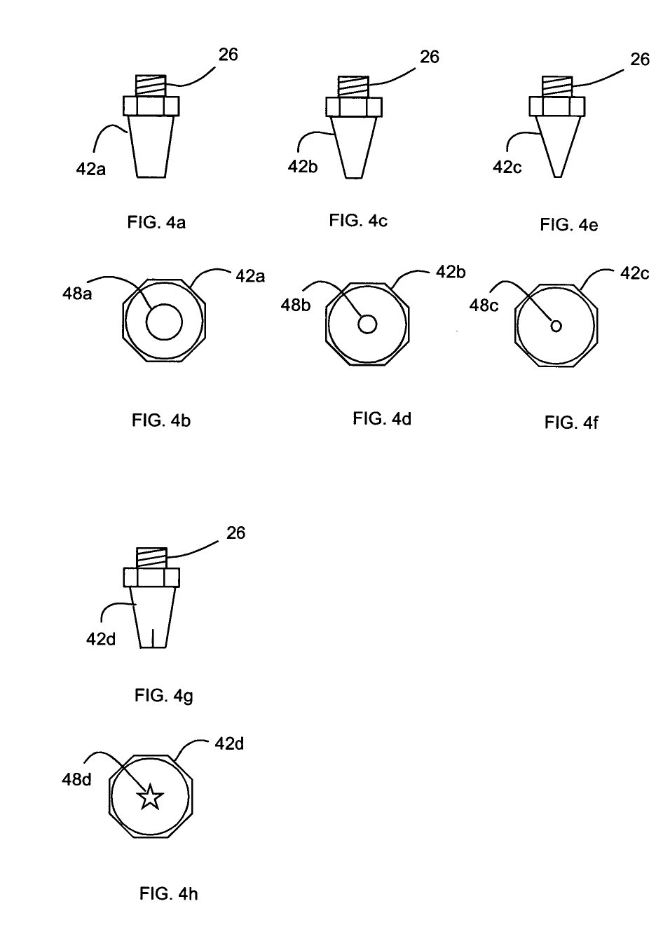

As shown in FIGS. 4a-f, the interchangeable punching tips 42 can include cutting orifices 48 of different sizes, to enable use of the tool to form larger or smaller holes, as desired. As shown, the size of the cutting orifices 48a-c decreases from tip 42a to tip 42c. Thus, if different sized holes are desired, the punching tip can be quickly and easily detached from the elongate body and a different tip can be quickly attached to the elongate body. Like the setting tips, the punching tips 42 can include threads 26 to allow threadable coupling to the elongate body. Of course, the interchangeable tips could also be configured with other coupling means, such as a snap-on tip, a press-on tip, etc.

The cutting orifices 48a-c shown in FIGS. 4a-f are formed in a circular shape, but of different sizes. However, the shape of the cutting orifice can also be varied in other ways, such as to include other geometric shapes, such as a square shape, a rectangular shape, or even a fanciful shape, such as an iconic or decorative shape. Examples of iconic or decorative shapes include stars, flowers, smiley faces, etc. For example, the punching tip 42d shown in FIGS. 4g-h provides a star-shaped cutting orifice 48d. Thus, the punching tips can be used to create holes of different shapes to create a pleasant aesthetic appearance. In addition, the chips 46 which are removed from the base material will be formed in a decorative shape, and can themselves be used to decorate pages.

Referring to FIGS. 5a and b, a method for fastening at least two mediums of a scrapbook or photo album, and for using the devices described above, is illustrated. Corresponding holes 44 are formed in the at least two mediums 22a and 22b. The holes can be formed simultaneously by stacking the mediums. Alternatively, the holes can be formed separately. The mediums 22a and 22b can be scrapbook pages, photo album pages, photos, and/or decorative paper. An interchangeable punching tip 42 can be attached to the elongate body 112. The holes 44 can be formed by placing the punching tip 42 against the mediums 22a and/or 22b, and striking the upper impact end 114 of the elongate body 112. The holes 44 in the mediums 22a and 22b are aligned, and an eyelet 21 disposed through the holes. The punching tip 42 can be removed from the elongate body 112 after forming the holes in the mediums. The setting tip 18 can then be attached to the elongate body. The setting tip 18 is placed against a top of the eyelet 21, and an upper impact end 114 of an elongate body is struck to deform the upper end of the eyelet 21. A setting tip with a raised pattern can be placed against the top of the eyelet so that striking sets the eyelet and creates a corresponding pattern of the raised pattern on the eyelet.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A combination punching and setting tool, comprising:
a) an elongate body, having an upper impact end, and a lower attachment end; and
b) at least one interchangeable tip, interchangeably received on the attachment end, the interchangeable tip being selected from the group consisting of i) a punching tip configured to punch an opening in a base material, and ii) a setting tip configured to set a securing device placed in an opening in the base material.

2. A tool in accordance with claim 1, further comprising a base material, and wherein the base material is selected from the group consisting of paper, card stock, and photographs.

3. A tool in accordance with claim 1, further comprising a securing device, and wherein the securing device is selected from the group consisting of an eyelet, a rivet, and a grommet.

4. A tool in accordance with claim 1, further comprising a securing device, and wherein the securing device comprises an eyelet, configured to be placed in a hole formed in the base material, and wherein the eyelet can be set around the hole in the base material by the combination tool.

5. A tool in accordance with claim 1, wherein the setting tip further comprises a raised pattern disposed on the tip, configured to create a corresponding pattern on the securing device upon setting the securing device.

6. A tool in accordance with claim 5, wherein the raised pattern is selected from the group consisting of geometric designs, pictures, alphanumeric characters, symbols, and logos.

7. A tool in accordance with claim 1, wherein the setting tip further comprises a sharp blade disposed on the tip, configured to score or cut the securing device upon setting the securing device.

8. A tool in accordance with claim 1, wherein the elongate body further comprises an ejection chute, formed in the body, and configured to allow base material punched by the punching tip to be ejected out of the elongate body.

9. A tool in accordance with claim 1, wherein the at least one interchangeable tip further comprises a plurality of punching tips, each tip having a cutting orifice configured to cut a hole in a base material, a size of a cutting orifice in each tip being different than a size of a cutting orifice in alternate tips.

10. A tool in accordance with claim 1, further comprising mating screw threads on the attachment end of the body and on the at least one interchangeable tip, the respective screw threads being configured to enable selective, threadable coupling of the at least one interchangeable tip to the body.

11. A tool in accordance with claim 10, further comprising a shoulder on the interchangeable tip, having a shape configured to facilitate attachment to and removal from the attachment end of the body.

12. A tool in accordance with claim 11, wherein the shoulder has a shape selected from the group consisting of hexagonal and octagonal.

13. A tool in accordance with claim 1, further comprising a knurled grasping portion disposed on the elongate body near the upper impact end.

14. A setting tool for setting a securing device, comprising:
a) an elongate body having an upper impact end and a lower end;
b) at least one setting tip, configured to contact the securing device to set it in a hole in a base material; and
c) a raised pattern, formed on a lower end of the setting tip, the tip being configured to strike and set the securing device, and to form a corresponding pattern in the securing device once set; and
d) the tool being configured to be struck at the impact end to drive the setting tip onto the securing device to set the securing device in the base material.

15. A setting tool in accordance with claim 14, wherein the setting tip is interchangeably attached to the lower end of the elongate body; and further comprising attachment means, disposed on a top of the setting tip and on the lower end of the elongate body for attaching the setting tip to the elongate body.

16. A setting tool in accordance with claim 14, further comprising a punching tip, interchangeably received on the attachment end of the elongate body, having a cutting orifice configured to cut a hole in a base material when the cutting orifice is placed upon the base material and the impact end of the elongate body is struck to drive the cutting orifice into the base material.

17. A setting tool in accordance with claim 16, further comprising an ejection chute, disposed in the elongate body, configured to allow base material punched by the punching tip to be ejected out of the elongate body.

18. A method for fastening at least two mediums of a scrapbook or photo album, comprising the steps of:
a) forming corresponding holes in the at least two mediums, the at least two mediums being selected from the group consisting of scrapbook pages, photo album pages, photos, and decorative paper;
b) aligning the holes in the at least two mediums;
c) disposing an eyelet through the holes in the at least two mediums;
d) placing a setting tip against a top of the eyelet; and
e) striking an upper impact end of an elongate body attached to the setting tip to deform the upper end of the eyelet.

19. A method in accordance with claim 18, wherein the step of placing a setting tip further includes placing a setting tip with a raised pattern against the top of the eyelet; and wherein the step of striking sets the eyelet and creates a corresponding pattern of the raised pattern on the eyelet.

20. A method in accordance with claim 18, wherein the step of forming corresponding holes further includes the steps of:
a) placing a punching tip against at least one of the mediums; and
b) striking an upper impact end of an elongate body attached to the punching tip to drive the punching tip through the at least one medium.

21. A method in accordance with claim 18, further comprising the steps of:
a) attaching an interchangeable punching tip to an elongate body prior to forming the holes in the mediums;
b) removing the punching tip from the elongate body after forming the holes in the mediums; and
c) attaching the setting tip to the elongate body prior to placing the setting tip against the top of the eyelet.
